(19) United States
(12) Patent Application Publication
(10) Pub. No.: US 2004/0035492 A1
(43) Pub. Date: Feb. 26, 2004

(54) Metering machine having a drum

(75) Inventor: Jean-Charles Marchadour, Pont-L' Abbe (FR)

Correspondence Address: Marina F. Cunningham, McCormick, Paulding & Huber LLP, CityPlace II, 185 Asylum Street, Hartford, CT, 06103, US

(73) Assignee: TREMARK TECHNOLOGIES INC, Mont Saint Hilaire (CA)

(21) Appl. No.: 10/644,373

(22) Filed: Aug. 20, 2003

(30) Foreign Application Priority Data
Aug. 21, 2002 (FR) 0210444

(51) Int. Cl. B67C 3/02

(52) U.S. Cl. 141/67

(57) ABSTRACT

A metering machine comprising a frame on which a hopper is mounted that is organized to receive a food to be metered out, and that has a bottom in the vicinity of which at least one feed duct opens out for feeding food to a metering device, and at least one drum. According to the invention, the drum is mounted on the frame to pivot about an axis that is substantially perpendicular to the feed duct so as to bring the chamber of said drum into a suction position in alignment with the feed duct, and into a delivery position offset angularly relative to said feed duct. The central hub of the drum is further equipped with a suction piston and with a delivery piston, which pistons slide between a deployed position inside the chamber in register and a retracted position out of said chamber.

This application is entitled to the benefit of and incorporates by reference essential subject matter disclosed in French Patent Application No. 02 10444 filed on August 21. 2002.

### FIELD OF THE INVENTION

The present invention relates to a metering machine that can be used in installations for packaging and in particular for canning thick foods such as meats, pates, corned beef, sauerkraut, non-chopped spinach, cabbage, etc., and foods in the form of semi-solid clumps such as grated carrot, with or without juice.

### BACKGROUND OF THE INVENTION

A metering machine generally comprises a frame receiving a hopper that serves to receive, in loose form, the food for canning, a duct that opens out in the hopper in the vicinity of a bottom thereof and that receives a portion of a transfer screw or “auger” extending along the bottom of the hopper, and a metering cylinder that slidably receives a suction and delivery piston. For reasons of compactness, the metering cylinder is disposed horizontally under the hopper. The bottom of the hopper and the duct are inclined relative to the horizontal so that the cylinder and the duct form an acute angle between them and are connected together via a plug valve. That type of machine is not adapted to all kinds of food because some foods, in particular grated carrot and sticky foods tend to form a blockage in the vicinity of the plug valve. If the blockage is not detected in time, and if the transfer screw is not stopped, the force opposing the movement of the food increases due to the blockage and increases the mechanical stresses to which the transfer screw and the drive members for driving said screw are subjected. That might damage one or more components of the machine. In addition, fragile foods including lumps might be partially split up or crushed as they go around the bend.

The state of the art is illustrated by Document DE-A-3 511 288 which describes a metering machine having a hopper at the base of which a metering system having a rotary drum is disposed. The drum is provide with radial chambers, each of which slidably receives a piston which is caused to slide by a stationary cam with which a wheel secured to the piston co-operates. It should be noted that that drum turns about a horizontal axis, and that each chamber is filled naturally under gravity. Provision is also made for the piston to be raised to the level of a bladed wheel for metering out the volume of powder.

In such a metering machine, the moving pistons remain inside the associated chambers while the drum is turning, which gives rise to moving equipment that is of considerable weight and that requires a motor of high power to turn it.

Reference can also be made to Document JP-A-2001 317 979 which describes a metering machine having slidably mounted cylinders and from which metered quantities are expelled.

### OBJECT OF THE INVENTION SUMMARY OF THE INVENTION

An object of the invention is to provide a metering machine that does not suffer from the drawbacks and limitations of the above-mentioned prior machines, and in particular a machine that is adapted to foods that are difficult to meter out, such as grated carrots or sticky foods, or to fragile foods in lumps.

### GENERAL DEFINITION OF THE INVENTION

The above-mentioned problem is solved in accordance with the invention by means of a metering machine comprising a frame on which a hopper is mounted that is organized to receive a food to be metered out, and that has a bottom in the vicinity of which at least one feed duct opens out for feeding food to a metering device, and at least one drum which has at least one radial chamber which opens out in the periphery of the drum, said metering machine being remarkable in that the drum is mounted on the frame to pivot about an axis that is substantially perpendicular to the feed duct so as to bring the chamber into a suction position in alignment with the feed duct, and into a delivery position offset angularly relative to said feed duct, said frame having a stationary central hub on which a rotary ring is mounted, in which ring the chamber is provided radially so as to open out in an inside circumference and in an outside circumference of the ring, and in that the drum is provided with means for sucking the food to be metered out into the chamber and for delivering the food out from the chamber, said means comprising a suction piston mounted on the hub to slide in alignment with the feed duct between a deployed position inside the chamber in register and a retracted position out of the chamber, and a delivery piston mounted on the hub to slide in a direction offset angularly relative to the feed duct between a deployed position inside the chamber in register and a retracted position out of the chamber in register.

Thus, the path of the foods between the hopper and the metering chamber is rectilinear, thereby limiting the risks of blockages forming with sticky foods, or of foods being damaged when they are fragile foods in lumps. In addition, the suction and delivery means are mounted on a portion that is stationary relative to the frame. It is then easier to connect them to an energy source, and the structure of the drum is relatively simple and of small weight.

Advantageously, provision is made such that, in the deployed position, the delivery piston has a front face that is flush with the outside circumference of the ring. This procures excellent accuracy for the metered volume.

Preferably, the ring is provided with a plurality of chambers organized in a manner such that when one of the chambers is in register with the suction piston, another of the chambers is in register with the delivery piston. The metering machine then makes it possible to obtain high throughput, thereby improving productivity.

Advantageously, the pistons are associated with means for actuating them simultaneously to go between their deployed position and their retracted position, and, preferably, the actuating means comprise two racks, each of which is secured to a respective one of the pistons, and a pinion which meshes with the racks and which is connected to an output shaft of a motor. The actuating means are thus of particularly simple structure.

According to a particular characteristic, the drum is mounted on the frame to move between an active position in which the chamber is in register with the feed duct and an inactive position in which the drum is spaced apart from the feed duct. The machine is thus made considerably easier to clean when the drum is in the inactive position.

Finally, advantageously, the drum is mounted on the frame to pivot eccentrically between the active position and the inactive position about an axis that is substantially parallel to a diameter of the drum and perpendicular to the feed duct.

Other characteristics and advantages of the present invention appear more clearly on reading the following description of a particular non-limiting embodiment of the invention.

### BRIEF DESCRIPTION OF THE DRAWINGS

Reference is made to the accompanying drawings, in which:

FIG. 1 is a diagrammatic view from above and partially in section of a metering machine of the invention;

FIG. 2 is a fragmentary view from above and partially in section of a metering machine of the invention, the drums being in the inactive position;

FIG. 3 is a section view on line III-III of FIG. 1, showing a drum whose pistons are in the deployed position; and

FIG. 4 is a view analogous to FIG. 3, showing the drum, the pistons of the drum being in the retracted position.

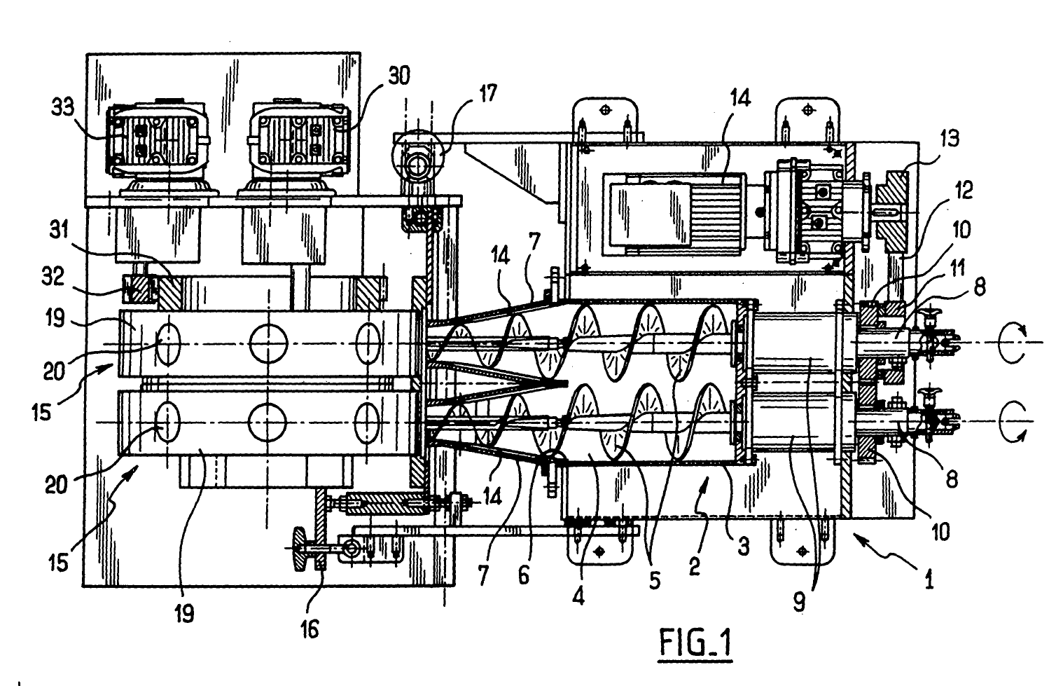

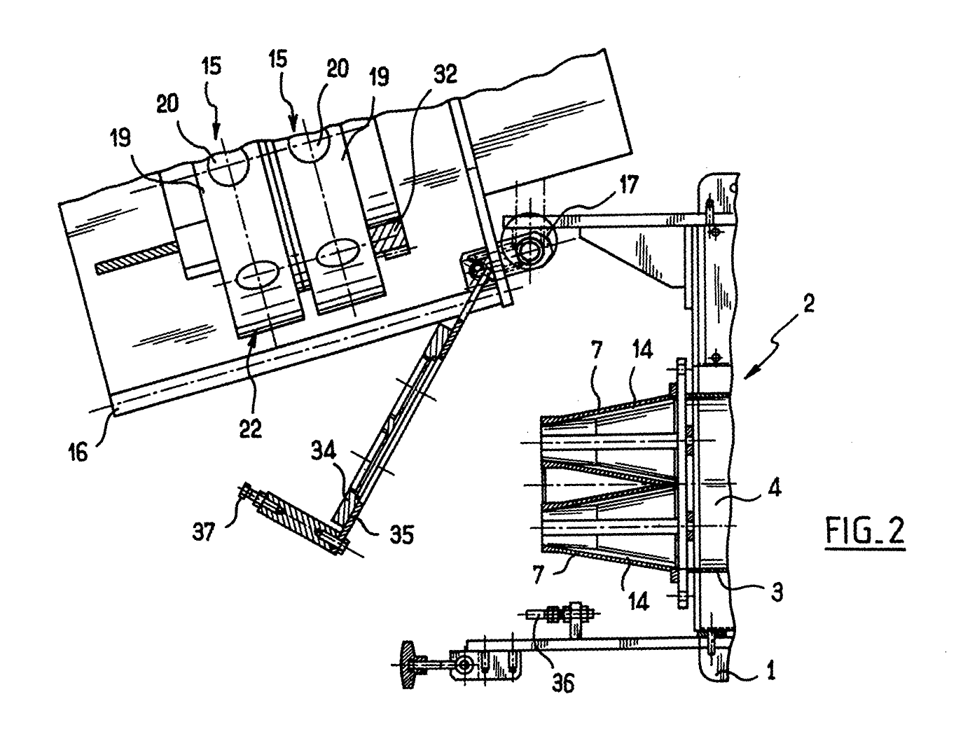

### DETAILED DESCRIPTION OF THE INVENTION

As shown in the figures, the metering machine of the invention comprises a frame 1 on which a hopper is mounted that is designated overall by reference 2, that is of vertical axis, and that is designed to receive, in loose form, the foods to be metered out and to be canned. The hopper 2 includes a vessel 3 (which is the only portion of the hopper 2 to be visible in the figures) defined by a side wall having one end closed off by a horizontal bottom 4 and its opposite end underlying a funnel optionally connected to the frame 1 via a hinge so as to tilt about a horizontal axis perpendicular to the axis of the hopper 2 a hinge so as to tilt about a horizontal axis perpendicular to the axis of the hopper 2 between a position in which it bears against the vessel 3 and a position in which it is moved out of the way backwards relative to the vessel 3.

Two transfer screws 5 extend horizontally at the bottom of the vessel 3. With reference to a food transfer direction, each transfer screw 5 has a downstream end that passes through an opening 6 provided in the side wall of the vessel 3 so as to project from the vessel 3 into a horizontal duct 7 which opens out in the vicinity of the bottom 4 of the vessel 3 and an upstream end that is secured to an end of a shaft 8 which passes through the side wall of the vessel and which is received in a bearing 9 mounted outside the vessel 3. The shafts 8 have their ends opposite from the transfer screws 5 equipped with gearwheels 10 which mesh with each other, and one of the shafts 8 is also provided at the same end with a driven pulley 11 connected via a belt 12 to a driving pulley 13 which is connected to an output shaft of a servomotor 14.

Each duct 7 has an inside surface surrounding the downstream end of the corresponding transfer screw 5. Axial grooves 14 are provided in said inside surface in order to constitute obstacles to the foods rotating about the axis of the transfer screw 5 so as to facilitate axial movement of said foods.

The metering machine further comprises a metering device comprising two drums generally referenced 15 which are mounted on a casing 16 connected to the frame 1 via a hinge 17 so as to pivot eccentrically in a horizontal plane between an active position in which the drums 15 are in register with ducts 6 and an inactive position in which the drums 15 are spaced apart from the ducts 6 so as to give unobstructed access to them.

Each drum 15 comprises a hub 18 which is fixed to the casing 16 and a ring 19 which is mounted on the hub 18 to pivot about a horizontal axis perpendicular to the axes of the ducts 6 when the casing is in the active position.

The ring 19 is provided with chambers 20 that extend radially to open out on one side in an inside circumference 21 of the ring 19 and on the other side in an outside circumference 22 of the ring 19. In this example, there are eight chambers 20 disposed at 45° from one another. The number of chambers 20 may however differ from eight.

The metering device further comprises means for sucking the food to be metered out into the chambers 20 and means for delivering the food from the chambers 20.

The suction and delivery means comprise a suction piston 23 mounted on the hub 18 so as to slide in alignment with the duct 6 between a deployed position inside the chamber 20 in register and a retracted position out of the chamber 20 in register, and a delivery piston 24 mounted on the hub 18 to slide in a direction offset by 90° relative to the suction piston 23 between a deployed position inside the chamber 20 in register and a retracted position out of the chamber 20 in register. The pistons 23 and 24 have front faces 25, 26 which, in the deployed position, are flush with the outside circumference 22 of the ring 19, and, in the retracted position, are flush with the inside circumference 21 of the ring 19. It should be noted that the angle between the suction piston 23 and the delivery piston 24 is a multiple of the angle between the chambers 20 so that, when one of the chambers 20 is in register with the suction piston 23, another of the chambers 20 is in register with the delivery piston 24.

Each piston 23, 24 is secured to a rack 27, 28 that meshes with a pinion 29 which extends transversely in the hubs 18 and which is connected to a drive motor 30. It should be noted that in order to enable the racks 27, 28 to mesh with the same pinion 29, they are mounted in respective different parallel planes.

In this example, the rings 19 of the drums 15 are constrained to rotate together and are driven via a toothed ring 31 which meshes with a gearwheel 32 secured to the output shaft of a motor 33.

When the casing 16 is in the active position, sealing elements 34 are pressed between the outside outline 22 of the ring 19 and the free ends of the ducts 6. The sealing elements 34 are secured to a support element 35 mounted to pivot on the casing 16. On its side facing the drums, the support element 35 has a curved surface that matches the outside outline 22, and on its side facing the ducts 7, said support element has a plane surface. It should be noted that, at its end opposite from its hinge axis about which it is hinged to the casing 16, the support element 35 bears against the frame 1 and against the casing 16 via adjustment screws 26, 37 which extend substantially parallel to the axes of the ducts 7 when the casing 16 is in the active position. This makes it possible to adjust the compression force that is exerted on the sealing elements 34 by forming a spacer of adjustable length between the casing 16 and the frame 1.

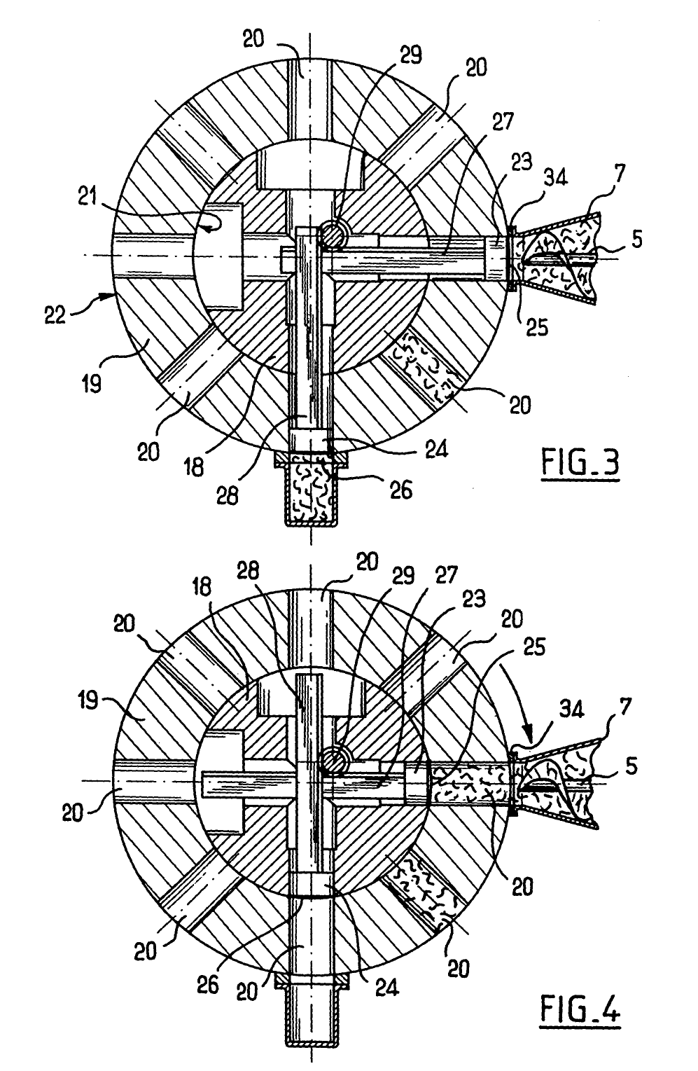

In operation, in each drum 15, with the pistons 23, 24 being in the deployed position (FIG. 3), the pinion 29 is actuated to bring the pistons 23, 24 into the retracted position. Food coming from the ducts 7 is then sucked into the chamber 20 in which the suction piston slides (see FIG. 3).

Once the pistons 23, 24 are in the retracted position, the ring 19 pivots through 45° so as to bring an empty chamber 20 into register with the suction piston 23, and so as to bring a full chamber 20 into register with the delivery piston (see FIG. 4).

The pistons 23, 24 are then brought into their deployed position. The delivery piston 24 then pushes the food contained in the chamber 20 in register with it into a can supported by a can feed device (not shown in the figures) while the suction piston 23 is brought to its deployed position in preparation for sucking in the next load of food (see FIG. 3).

The pistons 23, 24 are then brought to their retracted position so as to suck the food into the chamber 20 in register with the duct 7, and so as to enable the ring 19 to be turned. The cycle then continues as described above.

It can be observed that the fact the front face 25 of the suction piston 23 is flush with the inside circumference 21 of the ring 19 makes it possible to minimize the amount of food retained on said face when the ring 19 turns. The front face 26 of the delivery piston 24 coming flush with the outside circumference 22 of the ring 19 makes it possible to empty the chamber 20 entirely into the can.

In order to clean the ducts 6, the casing 16 is brought into its active position as is the support element 35 for supporting the sealing means 34.

Naturally, the invention is not limited to the embodiment described, and variant embodiments are possible without going beyond the ambit of the invention as defined by the claims.

In particular, a piston may be associated with each chamber for sucking in food and for delivering it.

In addition, the actuating means of the pistons may be independent for each piston, and they may be electrical, hydraulic, or pneumatic.

Furthermore, the quantity to be metered out may be smaller than the volume of the chamber 20.

What is claimed is:

1. A metering machine comprising a frame on which a hopper is mounted that is organized to receive a food to be metered out, and that has a bottom in the vicinity of which at least one feed duct opens out for feeding food to a metering device, and at least one drum which has at least one radial chamber which opens out in the periphery of the drum, wherein the drum is mounted on the frame to pivot about an axis that is substantially perpendicular to the feed duct so as to bring the chamber into a suction position in alignment with the feed duct, and into a delivery position offset angularly relative to said feed duct, said frame having a stationary central hub on which a rotary ring is mounted, in which ring the chamber is provided radially so as to open out in an inside circumference and in an outside circumference of the ring, and wherein the drum is provided with means for sucking the food to be metered out into the chamber and for delivering the food out from the chamber, said means comprising a suction piston mounted on the hub to slide in alignment with the feed duct between a deployed position inside the chamber in register and a retracted position out of the chamber, and a delivery piston mounted on the hub to slide in a direction offset angularly relative to the feed duct between a deployed position inside the chamber in register and a retracted position out of the chamber in register.

2. A metering machine according to claim 1, wherein, in the deployed position, the delivery piston has a front face that is flush with the outside circumference of the ring.

3. A metering machine according to claim 1, wherein, in the retracted position, the suction piston has a front face that is flush with the inside circumference of the ring.

4. A metering machine according to claim 1, wherein the ring is provided with a plurality of chambers organized in a manner such that when one of the chambers is in register with the suction piston, another of the chambers is in register with the delivery piston.

5. A metering machine according to claim 4, wherein the pistons are associated with means for actuating them simultaneously to go between their deployed position and their retracted position.

6. A metering machine according to claim 5, wherein the actuating means comprise two racks, each of which is secured to a respective one of the pistons, and a pinion which meshes with the racks and which is connected to an output shaft of a motor.

7. A metering machine according to claim 1, wherein the drum is mounted on the frame to move between an active position in which the chamber is in register with the feed duct and an inactive position in which the drum is spaced apart from the feed duct.

8. A metering machine according to claim 7, wherein the drum is mounted on the frame to pivot eccentrically between the active position and the inactive position about an axis that is substantially parallel to a diameter of the drum and perpendicular to the feed duct.
